(19) United States
(12) Patent Application Publication
(10) Pub. No.: US 2005/0251412 A1
(43) Pub. Date: Nov. 10, 2005

(54) System, apparatus, and method for providing customer apparatus information, and apparatus for collecting and managing such information

(76) Inventors: Tetsuya Miida, Tokyo (JP); Yayoi Katagiri, Saitama (JP); Takehiro Nishiura, Tokyo (JP); Isao Katsuta, Tokyo (JP); Hiroshi Nishida, Kanagawa (JP); Kiyohisa Minowa, Tokyo (JP); Haruo Hamaguchi, Tokyo (JP); Sachiko Misumi, Tokyo (JP); Tatsuto Torikai, Kanagawa (JP); Eiji Shinohara, Kanagawa (JP); Atsushi Hanai, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/178,495

(22) Filed: Jul. 12, 2005

Related U.S. Application Data
(63) Continuation of application No. 10/013,367, filed on Dec. 13, 2001.

(30) Foreign Application Priority Data
Dec. 15, 2000 (JP) 2000-382590
Mar. 12, 2001 (JP) 2001-069164

(51) Int. Cl. G06F 17/60; G09B 19/00

(52) U.S. Cl. 705/1

(57) ABSTRACT

A system for processing and providing information on an apparatus used by a customer includes an information collection part collecting information on usage of the apparatus, an information management part managing the information on usage, and a data processing part processing the information on usage in accordance with a request from a user of the information.

### BACKGROUND OF THE INVENTION

1. Field of the Invention

The present invention relates to a system, apparatus, and method for providing information on an apparatus used by a customer, and an apparatus for collecting and managing such information.

2. Description of the Related Art

Conventionally, it has been practiced to remotely monitor the state of an apparatus and perform necessary operations.

For instance, well known are a charge system that remotely monitors an amount of use of an apparatus and collects a charge according to the amount of use and a remote control system that monitors the state of an apparatus by remotely monitoring information on the quality of the apparatus.

However, the use or quality information of the apparatus alone is not sufficient as information on the apparatus required by a user thereof.

To a user who wishes to know how a copier is actually used in order to obtain the IS014001 certification, for instance, it is necessary to provide information such as the number of copies taken for each paper size as well as the total number of copies taken.

To a user who wishes to reduce copy-related costs, for instance, it is necessary to provide information such as the number of once-used sheets used for making another copy and the number of duplex copies made.

However, conventionally, there has been a problem that information that meets the needs of users of apparatuses cannot be provided properly when necessary.

Information on the use or quality of apparatuses alone is not sufficient for sales promotion so that salespersons are not fully supported only with such information.

Further, it has not been practiced to collect and process information on apparatuses used by customers (which information includes information on the quality of the apparatuses) in terms of providing assistance to the salespersons by providing the salespersons with meaningful information to the customers which information is processed to be useful for sales promotion.

Conventionally, paper media have mainly been used for manuals that provide instructions about how to operate a variety of apparatuses and note matters requiring attention in operating the apparatuses. However, an increase in the contents of the manuals due to the functional diversification of the apparatuses and the necessity of saving paper resources have caused electronic manuals having digitized contents to be widely used.

Such electronic manuals are provided as software, for instance, so as to be used in terminals such as personal computers and image data processing apparatuses such as copiers. In those cases, the electronic manuals are displayed on the terminals and on the display parts of the image processing apparatuses.

Since the contents of the electronic manuals are digitized, it is easy to make additions or modifications to the contents and, further, it is possible to search for a desired item by inputting a keyword, for instance. Therefore, compared with the paper manuals, the electronic manuals have many advantages.

While the functions of electronic apparatuses such as image data processing apparatuses are diversified, users generally use only limited functions according to their purposes of use and use conditions. However, since the electronic manuals cover almost all functions of the apparatuses, it costs users time and effort to search for their desired items. Further, since a broad range of difficult terms are employed in the electronic manuals as the functions are diversified, it is difficult for the users to understand the exact meanings of the terms. Therefore, even if the users use the keyword search function, the users are often prevented from obtaining their desired items in a short period of time.

Further, it is also difficult for the users to understand all of the diversified functions. Therefore, there are many convenient functions that are not used by the users who are unaware of or do not know how to use the functions.

Generally, the electronic manuals provide methods of recovering from failures caused in the apparatuses. However, if the apparatuses have the electronic manuals displayed on the display parts of their main bodies, the apparatuses are prevented from displaying the electronic manuals in the case of failures that affect the display functions of the apparatuses. In such a case, it may not be possible to make good use of the advantages of the electronic manuals.

Generally, a person who plans to purchase an apparatus uses catalogs as materials for comparison. However, it is difficult to describe all of the diversified functions of apparatuses in the catalogs. Further, mere introduction of the functions do not provide information on ease of use of the apparatuses. It is possible to know the ease of use of an apparatus by referring to its manual describing usage of each function. However, generally, the manual can be obtained only after actually purchasing a product. Therefore, it has been difficult to compare products before purchase in terms of ease of use.

### SUMMARY OF THE INVENTION

It is a general object of the present invention to provide a system, apparatus, and method for providing information on an apparatus used by a customer and an apparatus for collecting and managing such information in which the above-described disadvantages are eliminated.

A more specific object of the present invention is to provide a system, apparatus, and method for providing information on an apparatus used by a customer and an apparatus for collecting and managing such information by which a user (the customer) of the apparatus is properly provided with information on the apparatus matching the needs of the user when necessary, and the information on the apparatus is processed and provided to an information user such as a salesperson so that the information user may be supported.

Another more specific object of the present invention is to provide a system, apparatus, and method for providing information on an apparatus used by a customer by which noteworthy information is provided with priority to the customer according to a state of use of the apparatus.

Yet another more specific object of the present invention is to provide a system, apparatus, and method for providing information on an apparatus used by a customer by which an electronic manual is provided to an unspecified number of people.

The above objects of the present invention are achieved by a system for processing and providing information on an apparatus used by a customer, the system including an information collection part collecting information on usage of the apparatus, an information management part managing the information on usage, and a data processing part processing the information on usage in accordance with a request from a user of the information.

According to the above-described system, the information collection part, the information management part, and the data processing part enables the user of the apparatus to be properly provided with information on the apparatus matching the needs of the user when necessary, and the information on the apparatus to be processed and provided to the user of the information such as a salesperson so that the user of the information may be supported.

The above objects of the present invention are also achieved by an apparatus for collecting and managing information on a customer apparatus used by a customer, the apparatus including a collection part collecting information on usage of the customer apparatus via a network from the customer apparatus, a management part managing the collected information on usage, and a transmission part transmitting the collected information on usage to an information provision apparatus providing the information to a user of the information.

The above-described apparatus is suitable for the above-described system.

The above objects of the present invention are also achieved by an apparatus for processing information on a customer apparatus used by a customer and providing a report on the information, the apparatus including: a request processing part processing a request for provision of the information from a user of the information; a data acquisition part acquiring necessary data for preparing the report; a data processing part processing the information on the customer apparatus, the information being acquired by the data acquisition part; and a report preparation part preparing the report based on the necessary data including the information processed in the data processing part.

The above-described apparatus is suitable for the above-described system.

The above objects of the present invention are also achieved by a method of processing and providing information on an apparatus used by a customer, the method including the steps of (a) collecting information on usage of the apparatus, (b) managing the information on usage, and (c) processing the information on usage as requested by a user of the information.

The above objects of the present invention are also achieved by a method of processing information on an apparatus used by a customer and providing a report on the apparatus, the method including the steps of (a) processing a request for provision of the information from a user of the information, (b) acquiring necessary data for preparing the report, (c) processing the information on the apparatus, the information being acquired in the step (b), and (d) preparing the report based on the necessary data including the information on the apparatus processed in the step (c).

The above-described methods are suitable for the above-described system.

The above objects of the present invention are also achieved by a storage medium including a program for processing and providing information on an apparatus used by a customer, the program causing a computer to execute the steps of (a) collecting information on usage of the apparatus, (b) managing the information on usage, and (c) processing the information on usage as requested by a user of the information.

The above objects of the present invention are also achieved by a storage medium including a program for processing information on an apparatus used by a customer and providing a report on the apparatus, the program causing a computer to execute the steps of (a) processing a request for provision of the information from a user of the information, (b) acquiring necessary data for preparing the report, (c) processing the information on the apparatus, the information being acquired in the step (b), and (d) preparing the report based on the necessary data including the information on the apparatus processed in the step (c).

The above-described media store the programs suitable for the above-described system.

The above objects of the present invention are also achieved by a system for providing information to a terminal via a communication network, the system including an information collection part that collects information on usage of a product used by a customer via the communication network and stores the collected information, a manual selection part that analyzes the collected information on usage of the product and selects an electronic manual based on an analysis result, and a manual provision part that provides the selected electronic manual to the terminal via the communication network so that the electronic manual is output distinguishably from other information.

According to the above-described system, the information on usage of the product used by the customer is analyzed so that manual items that are noteworthy at the present moment can be output and presented with priority to the customer in such a way as to be distinguishable from other information according to the analysis result. For instance, the noteworthy manual items are displayed in a top page or more outstandingly than other information.

Additionally, the above-described system may further include a customer authentication part that accepts a request for provision of the electronic manual from the customer via the communication network and authenticates the customer.

Additionally, in the above-described system, the communication network may include a first communication network via which the information collection part collects the information on usage of the product and a second communication network via which the customer authentication part accepts the request and the manual provision part provides the electronic manual to the terminal.

Additionally, in the above-described system, the second communication network may be the Internet.

Thereby, manual information of a function of products such as image data processing apparatuses (copiers, for instance) which function is used by many users can be provided to an unspecified number of people via the Internet. This, for instance, allows manual information on a representative function of an image data processing apparatus to be provided to a person who considers purchasing the image data processing apparatus. Therefore, the person can be provided with a helpful material for comparison of the image data processing apparatus with similar products.

Further, by using the Internet, the customer or user can obtain manual information on the product with ease. The customer can also obtain the electronic manual showing a method of recovery from a failure even if the failure occurs in the product to prevent the electronic manual from being displayed on the product.

The above objects of the present invention are also achieved by a method of providing information to a terminal via a communication network, the method including the steps of (a) collecting information on usage of a product used by a customer via the communication network and storing the collected information, (b) analyzing the collected information on usage of the product and selecting an electronic manual based on an analysis result, and (c) providing the selected electronic manual to the terminal via the communication network so that the electronic manual is output distinguishably from other information.

Additionally, the above-described method may further include the step of (d) accepting a request for provision of the electronic manual from the customer via the communication network and authenticating the customer.

Additionally, in the above-described method, the communication network may include a first communication network via which the step (a) collects the information on usage of the product and a second communication network via which the step (d) accepts the request and the step (c) provides the electronic manual to the terminal.

Additionally, in the above-described method, the second communication network may be the Internet.

Thereby, the same effects as describe above can be produced.

The above objects of the present invention are further achieved by a server apparatus for providing information to a terminal via a communication network, the apparatus including an information collection part that collects information on usage of a product used by a customer via the communication network and stores the collected information, a manual selection part that analyzes the collected information on usage of the product and selects an electronic manual based on an analysis result, and a manual provision part that provides the selected electronic manual to the terminal via the communication network so that the electronic manual is output distinguishably from other information.

Additionally, the above-described server apparatus may further include a customer authentication part that accepts a request for provision of the electronic manual from the customer via the communication network and authenticates the customer.

Additionally, in the above-described server apparatus, the communication network may include a first communication network via which the information collection part collects the information on usage of the product and a second communication network via which the customer authentication part accepts the request and the manual provision part provides the electronic manual to the terminal.

Additionally, in the above-described server apparatus, the second communication network may be the Internet.

Thereby, the same effects as described above can be produced.

### BRIEF DESCRIPTION OF THE DRAWINGS

Other objects, features and advantages of the present invention will become more apparent from the following detailed description when read in conjunction with the accompanying drawings, in which:

FIG. 1 is a diagram showing a customer apparatus information provision system according to a first embodiment of the present invention;

FIG. 2 is a diagram showing a configuration of a customer apparatus information collection and management apparatus of the system of FIG. 1;

FIG. 3 is a diagram showing a configuration of a customer apparatus information provision apparatus of the system of FIG. 1;

FIG. 4 is a diagram showing a configuration of a customer apparatuses of the system of FIG. 1;

FIG. 5 is a flowchart of an operation performed by a salesperson in obtaining information on the customer apparatus of her/his customer;

FIG. 6 is another flowchart of the operation performed by the salesperson in obtaining the information on the customer apparatus of her/his customer;

FIG. 7 is a flowchart of an operation performed by the customer in obtaining the information on its customer apparatus;

FIGS. 8A through 8F are diagrams for illustrating a usage report;

FIG. 9 is a diagram showing detailed copier usage information;

FIG. 10 is a diagram showing a graph set;

FIG. 11 is a schematic diagram showing a configuration of a system for providing an electronic manual according to a second embodiment of the present invention;

FIG. 12 is a block diagram showing a configuration of a center of the system of FIG. 11;

FIG. 13 is a diagram showing customer information recorded on a customer ID database of the center of FIG. 12;

FIG. 14 is a block diagram showing configurations of a copier and a transmission apparatus of the system of FIG. 11;

FIG. 15 is a flowchart of an information collection operation performed by the system of FIG. 11;

FIG. 16 is a diagram showing usage information collected in the information collection operation of FIG. 15;

FIG. 17 is a flowchart of an information provision operation performed by the system of FIG. 11;

FIG. 18A is a diagram showing a menu page screen provided in the information provision operation of FIG. 17, and FIG. 18B is a diagram showing an identification number input screen for customer authentication provided in the information provision operation of FIG. 17;

FIG. 19 is a flowchart of a usage analysis operation performed in the information provision operation of FIG. 17;

FIG. 20 is a flowchart of a usage analysis operation performed in the information provision operation of FIG. 17;

FIG. 21 is a flowchart of a usage analysis operation performed in the information provision operation of FIG. 17;

FIG. 22 is a flowchart of a usage analysis operation performed in the information provision operation of FIG. 17;

FIG. 23 is a flowchart of a usage analysis operation performed in the information provision operation of FIG. 17;

FIG. 24 is a flowchart of a usage analysis operation performed in the information provision operation of FIG. 17;

FIG. 25 is a diagram showing a configuration of a manual page created in the information provision operation of FIG. 17; and

FIG. 26 is a flowchart of an expected purchaser page operation performed in the information provision operation of FIG. 17.

### DETAILED DESCRIPTION OF THE PREFERRED EMBODIMENTS

A description will now be given, with reference to the accompanying drawings, of embodiments of the present invention.

### First Embodiment

A description will be given of a first embodiment of the present invention.

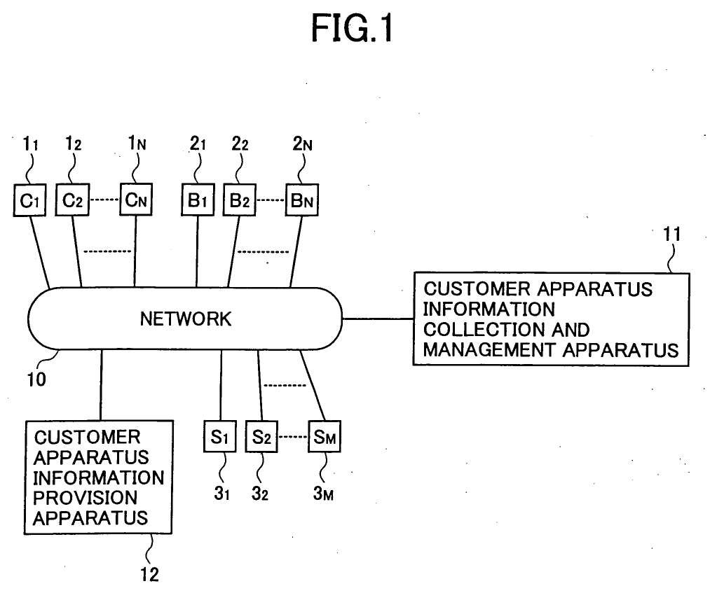

FIG. 1 is a diagram showing a system for providing information on apparatuses located at customers (a customer apparatus information provision system) according to the first embodiment of the present invention. The system is composed of apparatuses 1₁ through 1_{N} used by customers, terminals 2₁ through 2_{N} of the customers, terminals 3₁ through 3_{N} of salespersons, a network 10, an apparatus 11 collecting and managing information on the apparatuses 1₁ through 1_{N} used by the customers (a customer apparatus information collection and management apparatus 11), and an apparatus 12 providing the information on the apparatuses 1₁ through 1_{N} used by the customers (a customer apparatus information provision apparatus 12). The apparatuses 11 and 12 may be integrated into one apparatus.

The network 10 is a communication network such as the Internet or a telephone line network. The customer apparatuses 1₁ through 1_{N} are connected via the network 10 to the customer apparatus information collection and management apparatus 11. The customer apparatuses 1₁ through 1_{N} may be connected to the apparatus 11 via a network other than the network 10, such as a private line network.

The customer apparatuses 1₁ through 1_{N} are printers, copiers, and facsimile machines used in offices and at home, for instance. The customer apparatus information collection and management apparatus 11 collects and manages information on usage and the quality of each of the customer apparatuses 1₁ through 1_{N}. The apparatus 11 processes and transmits the collected information to the customer apparatus information provision apparatus 12 as required. The apparatus 12 can access the storage part of the customer apparatus information collection and management apparatus 11 to freely obtain the usage and quality information stored in the storage part.

The customer terminals 2₁ through 2_{N} are the communication terminals of the customers using the apparatuses 1₁ through 1_{N}. The customers can access the customer apparatus information provision apparatus 12 to obtain the information on the apparatuses 1₁ through 1_{N} easily via the network 10 as required.

The salesperson terminals 3₁ through 3_{N} are the communication terminals of the salespersons. The salespersons can access the customer apparatus information provision apparatus 12 to obtain the information on the apparatuses 1₁ through 1_{N} of their respective customers easily via the network 10 as required. Thereby, the salespersons can provided proper information to their customers.

The salesperson terminals 3₁ through 3_{N} may be connected to the customer apparatus information provision apparatus 12 via a network other than the network 10, such as a groupware network. The salesperson terminals 3₁ through 3_{N} may be connected directly to the apparatus 12.

According to the customer apparatus information provision system of FIG. 1, collection of the information on the customer apparatuses 1₁ through 1_{N} is performed by the customer apparatus information collection and management apparatus 11 including a server computer through electrical signals via the network 10, management of the collected information is performed by the customer apparatus information collection and management apparatus 11, processing of the collected information is performed by the customer apparatus information collection and management apparatus 11 and/or the customer apparatus information provision apparatus 12 including a server computer, and provision of the collected and/or processed information is performed by the customer apparatus information provision apparatus 12 through electrical signals via the network 10. The customer terminals 2₁ through 2_{N} and the salesperson terminals 3₁ through 3_{N} each include a central processing unit (CPU) for operation control, a memory for temporarily storing the information transmitted from the customer apparatus information provision apparatus 12 through electrical signals via the network 10, and a display such as a CRT for displaying the information to each customer or salesperson. The apparatuses 11 and 12 are connected by the network 10 so as to transmit information to and receive information from each other through electrical signals via the network 10.

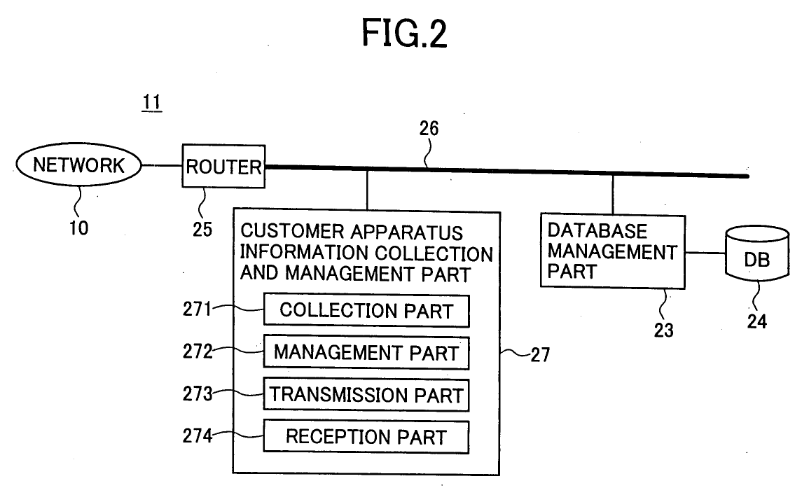

FIG. 2 is a diagram showing a configuration of the customer apparatus information collection and management apparatus 11. The apparatus 11 of FIG. 2 is composed of a database management part 23, a database (DB) 24, a communication router 25, a bus 26, a customer apparatus information collection and management part 27, and a local area network (LAN) 26. The apparatus 11 of FIG. 2 is connected to the network 10.

The customer apparatus information collection and management apparatus 11 may further include a processing part that informs failures in the customer apparatuses 1₁ through 1_{N}, a processing part that transmits information on supplies to the customer apparatuses 1₁ through 1_{N} (supply information), a processing part that manages the alarms of the customer apparatuses 1₁ through 1_{N}, and a processing part that deals with failures in the customer apparatuses 1₁ through 1_{N} so as to function as a customer support center that supports the customers based on the information on their respective customer apparatuses 1₁ through 1_{N}.

The communication router 25 provides an interface between the network 10 and the bus 26 and has a routing function.

The customer apparatus information collection and management part 27 includes a collection part (an information collection part) 271 that collects the usage information of each of the customer apparatuses 1₁ through 1_{N} periodically or when necessary, a management part (an information management part) 272 that manages the collected usage information, a transmission part 273 that transmits the collected usage information as it is or after processing the information to the customer apparatus information provision apparatus 12 based on a request therefrom, and a reception part 274 that receives the usage and quality information of each of the customer apparatuses 1₁ through 1_{N} and an information request signal transmitted from the customer apparatus information provision apparatus 12.

The customer apparatus information collection and management part 27 collects the usage and quality information of each of the customer apparatuses 1₁ through 1_{N} via the network 10 and manages the information.

The usage information includes information on an amount of use of the customer apparatus, such as a percentage of the number of sheets used of each size, a percentage of the number of sheets used of each paper feeding tray, a percentage of the number of duplex copies taken, the number of sheets used of each size, the number of sheets used of each paper feeding tray, the number of duplex copies taken, and the transition of the monthly data of each of the above-described proportions and numbers, cost information such as costs at the present moment and the expected costs of the current month, and supply information such as an amount of expendable supplies consumed and the shortage or replenishment information of the expendable supplies.

The quality information includes failure information indicating failures in the customer apparatus and alarm information indicating that the customer apparatus does not contain failures but requires maintenance.

Further, the quality information includes information of other categories, such as the number of serviceman calls (SCs) that are transmitted when failures are detected by self-diagnoses performed by the customer apparatus, the number of emergency auto-calls (CCs) that are transmitted when five paper jams of the same tendency occurs in a row, the number of alarm calls (ACs) that are transmitted when the customer apparatus does not contain failures but requires maintenance, and the number of manual calls (MCs) that are transmitted when the customer informs a problem by a panel operation. The problem may be informed by the serviceman call.

Further, the customer apparatus information collection and management part 27 can obtain the information on each of the customer apparatuses 1₁ through 1_{N} periodically or when necessary as required.

The database management part 23 manages the database 24. The database 24 stores the collected usage and quality information of each of the customer apparatuses 1₁ through 1_{N}. The customer apparatus information provision apparatus 12 provides the information to the information users as it is or after processing the information. The database 24 further stores data for obtaining the cost and supply information.

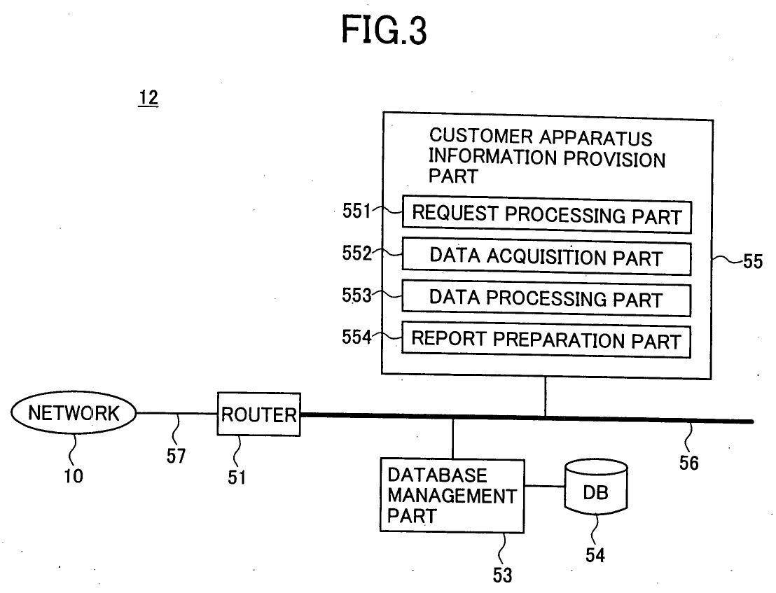

FIG. 3 is a diagram showing a configuration of the customer apparatus information provision apparatus 12.

The apparatus 12 of FIG. 3 is composed of a communication router 51, a database management part 53, a database (DB) 54, a customer apparatus information provision part 55, and a bus 56. The apparatus 12 of FIG. 3 is connected to the network 10.

The communication router 51 provides an interface between the network 10 and the bus 56, and has a routing function.

The database management part 53 manages the database 54. The database 54 stores necessary information for providing the information on each of the customer apparatuses 1₁ through 1_{N} That is, the database 54 stores information that is required to provide the information on the customer apparatus, but is not the information on the customer apparatus. For instance, the database 54 stores information such as information on a person in charge and topic information that is required to prepare a requested report and is used in the report, but is not the information on the customer apparatus. The information on each of the customer apparatuses 1₁ through 1_{N} is obtained from the customer apparatus information collection and management part 27. Therefore, basically, the database 54 is not required to store that information. However, the database 54 may store the information or processed information on each of the customer apparatuses 1₁ through 1_{N} if the information is frequently used.

The customer apparatus information provision part 55 includes a request processing part 551 that processes requests for provision of information from the information users, a data acquisition part 552 that acquires necessary data for preparing reports, a data processing part 553 that processes the information on each of the customer apparatuses 1₁ through 1_{N} acquired by the data acquisition part 552, a report preparation part 554 that prepares the reports from the necessary data including the information processed in the data processing part 554. Thereby, the customer apparatus information provision part 55 performs necessary processing to provide the information on each of the customer apparatuses 1₁ through 1_{N} by using the data stored in the database 54 and the data obtained from the customer apparatus information collection and management part 27.

The data processing part 553 processes the data so that the data is easy to use, and creates the cost and supply information of the amount of use of each of the customer apparatuses 11 through ¹N. The data processing part 553 may be configured to process at least one of data at the present moment, accumulated data, and data of each given period of time. Further, the data processing part 553 may be configured to process at least one of data on time, data on costs, and data on expendable supplies.

The customer apparatus information collection and management apparatus 11 may perform the processing of the data processing part 553.

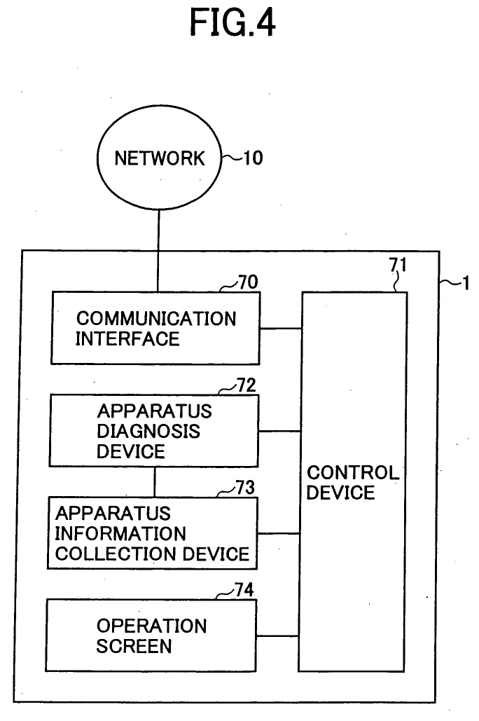

FIG. 4 is a diagram showing a configuration of one of the customer apparatuses 1₁ through 1_{N}. Since the customer apparatuses 1₁ through 1_{N} have the same configuration, the one shown in FIG. 4 is referred to as a customer apparatus 1 for simplicity purposes. Information such as the usage information, the failure information, and the alarm information is transmitted from the customer apparatus 1 to the customer apparatus information collection and management apparatus 11.

The customer apparatus 1, which is an apparatus such as a printer, a copier, or a facsimile used in an office or at home, includes, in its main body, a communication interface 70, a control device 71, an apparatus diagnosis device 72, an apparatus information collection device 73, and an operation screen 74.

The control device 71 controls the entire apparatus 1. Further, the control device 71 also controls the communication interface 70, the apparatus diagnosis device 72, the apparatus information collection device 73, and the operation screen 74.

The apparatus diagnosis device 72 performs self-diagnosis on the customer apparatus 1, and transmits the result via the communication interface 70 to the customer apparatus information collection and management apparatus 11.

The apparatus diagnosis device 72 determines whether the apparatus 1 is in a failed state or is not in a failed state but requires maintenance, and transmits this information to the customer apparatus information collection and management apparatus 11 as the failure or alarm information.

The usage information includes the amount of use of the apparatus 1.

The failure information represents a state of the apparatus 1 when the result of the self-diagnosis based on information supplied from a sensor provided to the apparatus 1 shows that the apparatus 1 requires service or maintenance by its manufacture, leasing company, etc.

The above-described information is expressed as information codes and stored in the buffer of the apparatus diagnosis device 72. Thereafter, the information is transmitted to the customer apparatus information collection and management apparatus 11 in a format compatible with the network 10.

The customer can inform the customer apparatus information collection and management apparatus 11 of a problem in the apparatus 1 by using the operation screen 74.

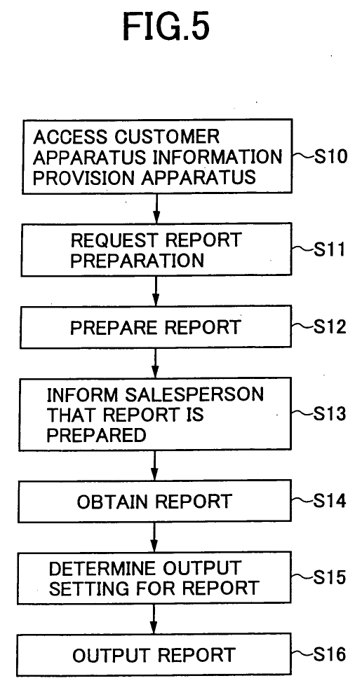

A description will be given, with reference to FIG. 5, of a case where the salesperson obtains a report on the apparatus 1 of her/his customer.

In step S10, the salesperson accesses the customer apparatus information provision apparatus 12 by using his/her terminal 3, which may be any of the terminals 3₁ through 3_{N} of FIG. 1.

Next, in step S11, the salesperson makes a request that a report on the information on the apparatus 1 of her/his customer be prepared. The request is made by inputting a requester's phone number (essential), a salesperson division code (essential), an apparatus model code (essential), an apparatus number (essential), and a customer name (optional) or a customer code (optional). Input information is not limited to those described above.

As the apparatus number, a conventional number provided at the time of production or an address of Internet Protocol Version 6 (Ipv6) may be employed. If the address of Internet Protocol Version 6 (Ipv6) is employed, basically, it is unnecessary to input the apparatus model code.

Next, in step S12, the customer apparatus-information provision part 55 of the customer apparatus information provision apparatus 12 prepares the report.

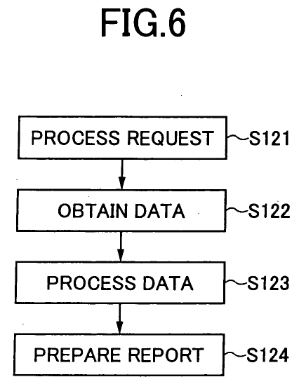

A description will be given, with reference to FIG. 6, of a flow of the operation of preparing the report. First, in step S121, the customer apparatus information provision part 55 processes the request from the salesperson, that is, accepts the contents of the request from the salesperson. Then, in step S122, the customer apparatus information provision part 55 accesses the database 54 and the database 24 of the customer apparatus information collection and management apparatus 11 to obtain necessary data for the request from the salesperson. Next, in step S123, the customer apparatus information provision part 55 processes data in need of processing in the following manner:
(A) Prepare the report in a requested format.
(B) Make a requested graph of data whose graph is requested.
(C) Process raw data into a table.
(D) Process data for other requested particulars.

Thereafter, in step S124, the customer apparatus information provision part 55 prepares the requested report for the salesperson.

Referring back to FIG. 5, after preparing the report for the salesperson, in step S13, the customer apparatus information provision apparatus 12 stores the report in the database 54 or in another storage part, and at the same time informs the requester that the requested report for the salesperson has been prepared.

If the terminal 3 of the salesperson and the customer apparatus information provision apparatus 12 are connected via the Internet or the like, a completion mail is transmitted to the requester. Similarly, if the terminal 3 of the salesperson and the customer apparatus information provision apparatus 12 operate on groupware, a completion mail is transmitted from the server of the groupware to the requester. The server of the groupware may be or may not be the customer apparatus information provision apparatus 12.

Receiving the completion mail, in step S14, the salesperson accesses the database 54 (or the other storage part where the report is stored) of the customer apparatus information provision apparatus 12 and obtains the report. Thereafter, in step S15, the salesperson determines an output setting for the received report, and in step S16, outputs, for instance, a printout of the report.

The output report is composed of a usage report, detailed apparatus use information, and graphs. An output format is not limited to this.

The data of the received report is processible and the salesperson can process, edit, and correct the report data so as to output a desired report.

The report data obtained at the terminal 3 of the salesperson may be composed of the following sheet data: input sheet data, usage report sheet data, detailed apparatus use information sheet data, and graph sheet data.

The salesperson can change the output format of the report by using the input sheet data. Thereby, the salesperson can output a document that is suitable for her/his customer.

The salesperson can also correct default items in the report by using the input sheet data. Further, by using the input sheet data, the salesperson can newly create a graph and insert the graph into the received report, or can prepare another report. Thereby, the salesperson can output a report that matches the needs of her/his customer.

According to this embodiment, the customer apparatus information provision apparatus 12 informs the salesperson of the completion of the preparation of the report after preparing the report, and the informed salesperson accesses the database 54 of the customer apparatus information provision apparatus 12 to obtain the report. However, if the customer apparatus information provision apparatus 12 is capable of quickly preparing the report for the salesperson, the salesperson may obtain the report after waiting for a while with the report being requested.

Similarly, the customer may obtain the information on the customer apparatus 1 by accessing the customer apparatus information provision apparatus 12.

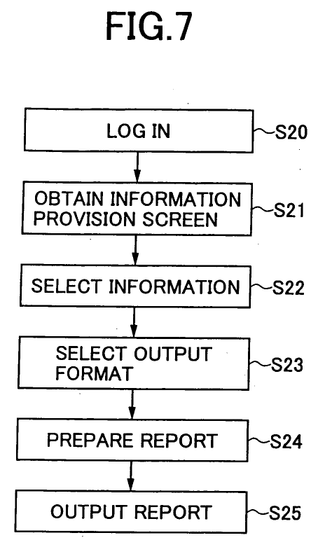

A description will be given, with reference to FIG. 7, of a case where the customer apparatus information provision system of this embodiment is compatible with the Internet.

When the customer wishes to know the number of once-used sheets used for making another copy and the number of duplex copies made to know how a copier is actually used or to reduce copy-related costs so as to obtain the IS014001 certification, in step S20, the customer logs in by inputting its password and customer ID number.

Next, in step S21, the customer selects “customer apparatus information provision” on an initial screen and obtains a customer information provision screen (not shown in the drawing). In step S22, on the customer information provision screen, the customer makes selection as to a purpose of using information provision, information to be provided, a data period, and a data type. In step S23, the customer makes selection as to an output format (for instance, a table or graph) in which the information is output, and presses down a transmission button (not shown in the drawing).

Then, in step S24, the customer apparatus information provision part 55 of the customer apparatus information provision apparatus 12 obtains necessary data under the specified conditions, converts the data into the specified format, and prepares a report. In step S25, the customer apparatus information provision part 55 outputs the result to the customer.

When the customer thus obtains the information on its customer apparatus 1 by using this system, the contents of the report may be transmitted to the salesperson after or at the same time that the salesperson is informed that the report has been prepared. As a result, problems that the customer is currently aware of can be understood.

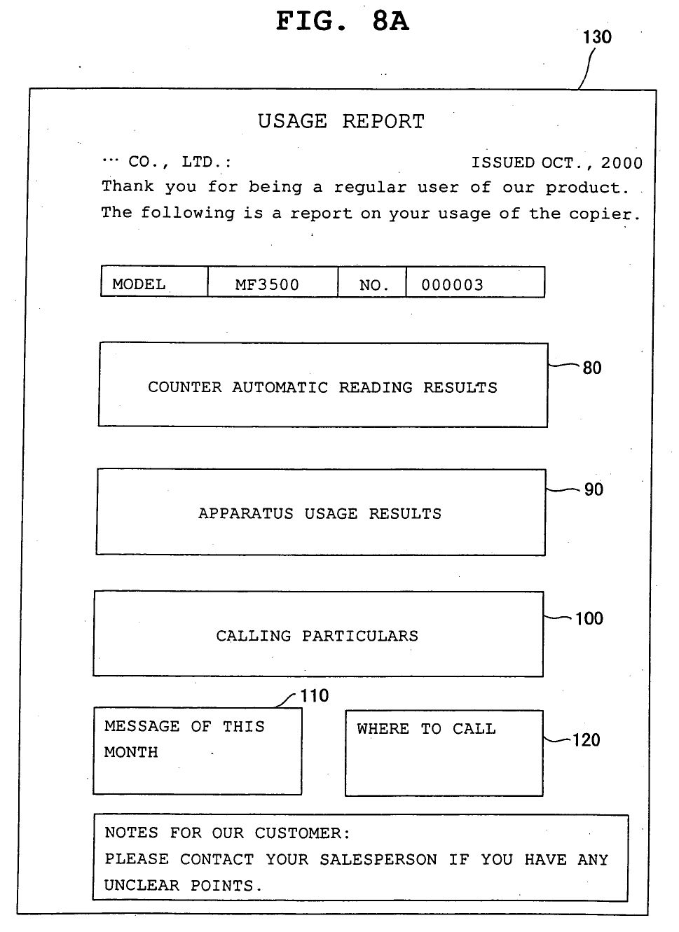

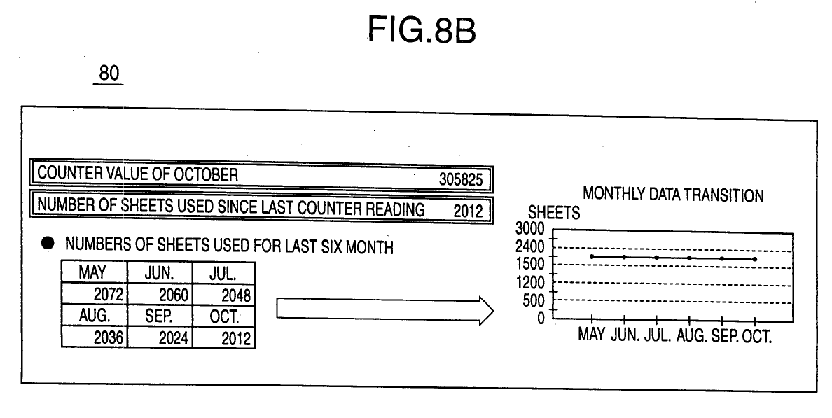

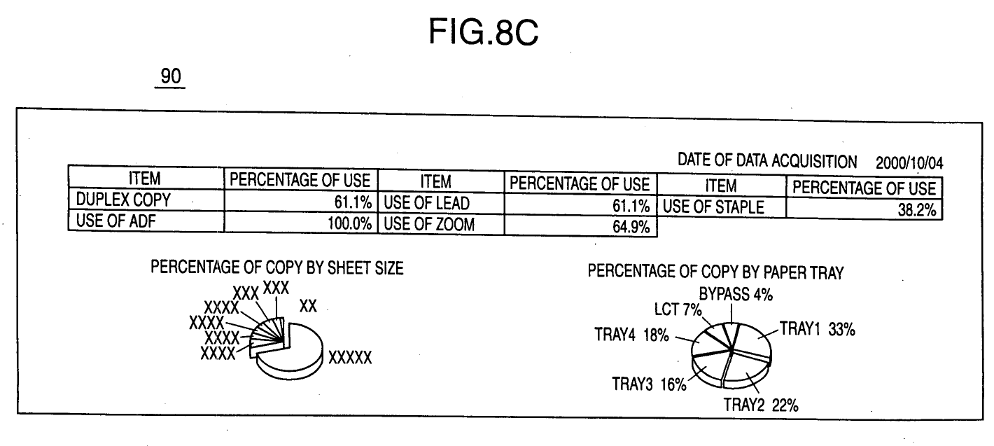

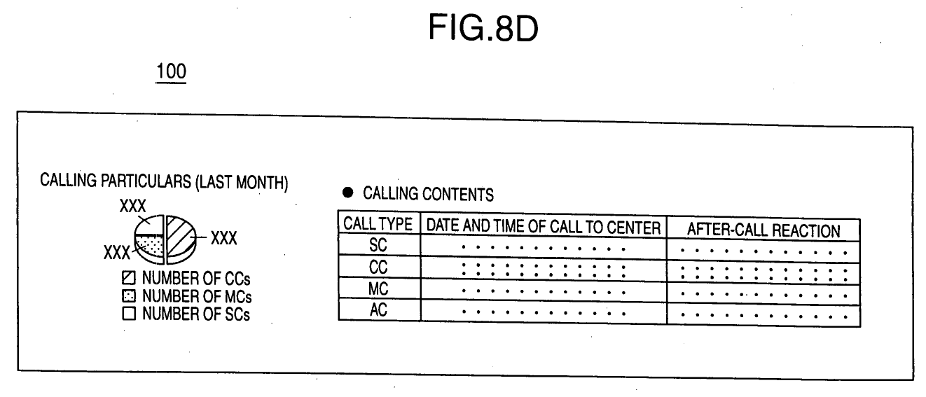

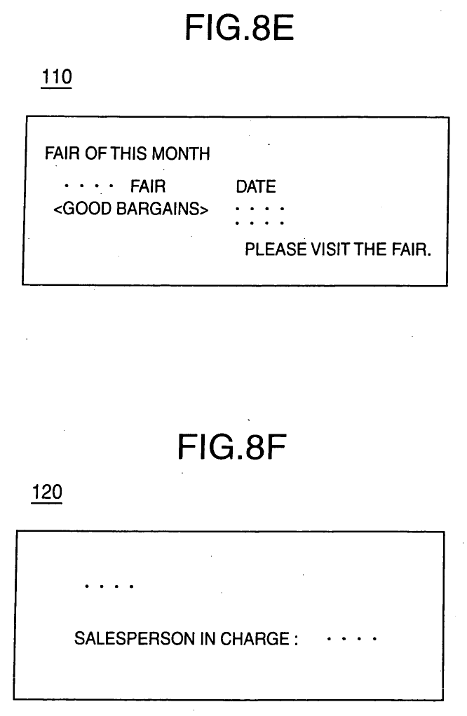

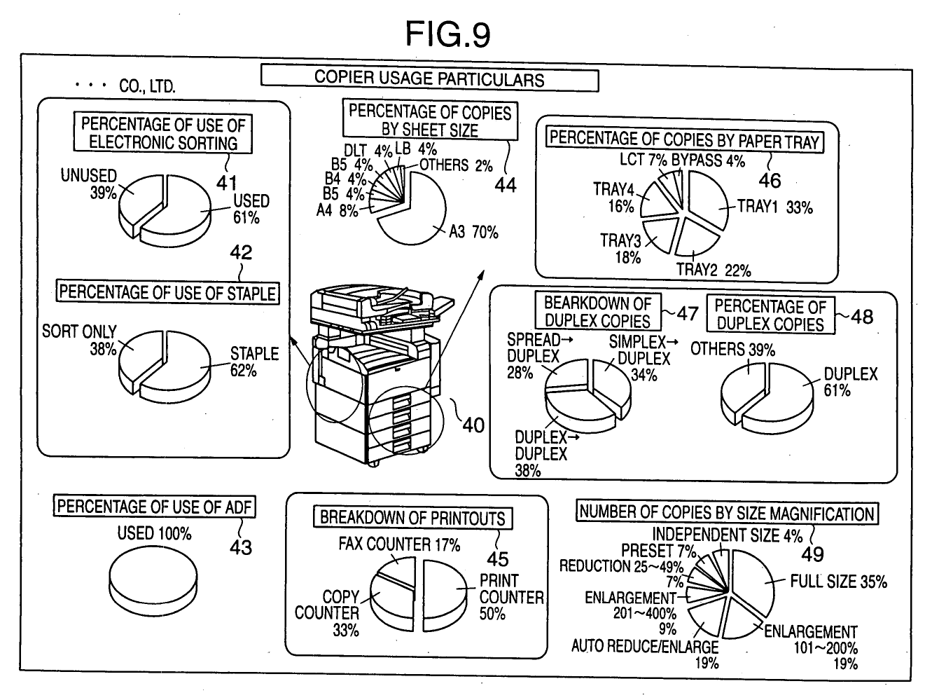

FIG. 8A is a diagram showing a usage report 130 for a customer. According to FIG. 8A, the usage report 130 is prepared to include counter automatic reading results 80, apparatus usage results 90, calling particulars 100, a message of this month 110, and a where to call 120, which are shown in detail in FIGS. 8B through 8F, respectively. Here, the usage report 130 is prepared for a copier 40 shown in FIG. 9, for instance.

The counter automatic reading results 80 include the total counter value of the copier 40 from its installation up to the present and the transition of the monthly data of the number of sheets used for the last six months. In addition to these, the counter automatic reading results 80 may further include the number of sheets used during a period from the last counter reading up to today, a charge for the period from the last counter reading up to today, charge particulars, and changes in monthly charges and monthly charge particulars.

The apparatus usage results 90 includes a percentage of the number of sheets used of each size, a percentage of the number of sheets used of each paper feeding tray, and a percentage of the number of duplex copies taken. In addition to these, the apparatus usage results 90 may further include the number of sheets used of each size, the number of sheets used of each paper feeding tray, the number of duplex copies taken, and the transition of the monthly data thereof.

Thereby, if it is determined that a certain paper feeding tray is loaded with once-used sheets, the number of once-used sheets used for making another copy can be obtained.

The calling particulars 100 show the number of calls of each call type, which is obtained from the information on the customer apparatus 1. Other than this, the calling particulars may further include the date and time of each of the latest CC, SC, MC, and AC made.

The message of this month 110 shows a message for the customer. If the above-described data show that it is time to replace the copier 40 by purchase, the message of this month 110 may show a message to that effect. The where to call 120 shows the name of a salesperson in charge of the customer. The message of this month 110 and the where to call 120 use data stored in the database 54 of the customer apparatus information provision apparatus 12.

By this usage report 130, the information users, that is, the salesperson and the customer, can visually recognize usage of the apparatus 1 with ease.

The usage report 130 may not limited to the contents described above. For instance, the usage report 130 may include information on expendable supplies and costs. That is, the usage report 130 may include an amount of expendable supplies consumed, costs, and the transition of the monthly data thereof.

Further, the customer may obtain any data in any format by making selection as to a purpose of using information provision, information to be provided, a data period, and a data type. Further, the customer may modify the obtained report. Furthermore, a given data set may be attached to the report so that the customer may freely modify the report.

The customer may obtain the report at any time. The report may be transmitted to the customer periodically based on a contract if it is so predetermined thereby.

The salesperson may obtain this usage report 130 and present the customer with the report when the salesperson visits the customer. In this case, the salesperson can use the column of the message of this month 110 and give a message to the customer. Further, the salesperson can prepare an individual proposal, report, or leaflet for the customer by using graphs.

FIG. 9 is a diagram showing detailed copier usage information for the customer and the salesperson. The detailed copier usage information is composed of graphs showing copier usage particulars as shown in FIG. 9. The copier usage particulars may be represented by a table. In FIG. 9, the graphs show percentage of use of electronic sorting 41, percentage of use of staple 42, percentage of use of automatic document feeding (ADF) 43, percentage of copies by sheet size 44, a breakdown of printouts 45, percentage of copies by paper feeding tray 46, a breakdown of duplex copies 47, percentage of duplex copies 48, and number of copies by size magnification 49. The contents of the detailed copier usage information are not limited to the above-described particulars.

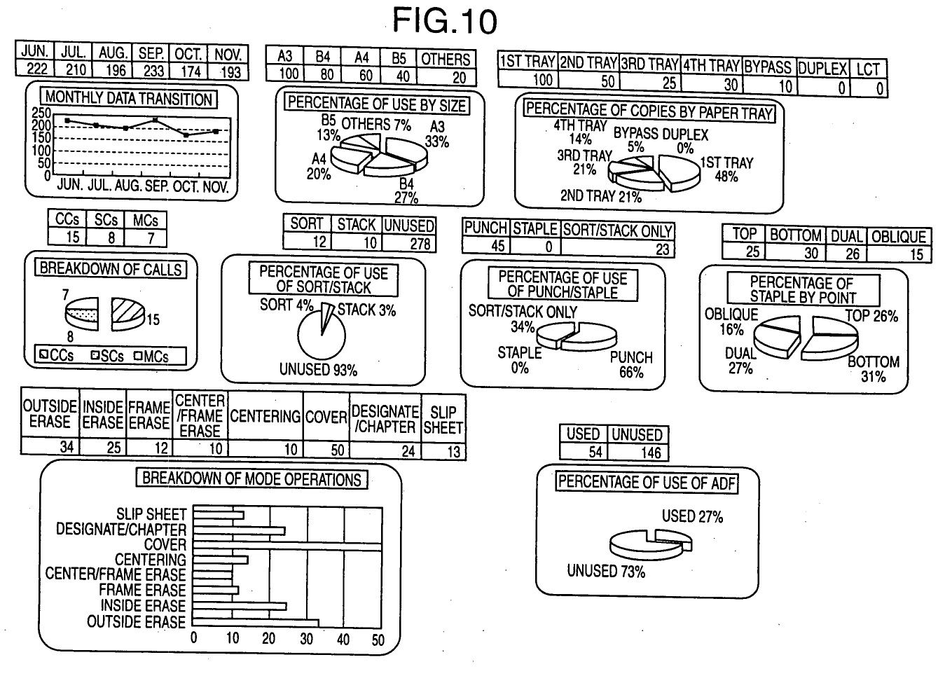

The detailed copier usage information may be printed out separately, or as an attachment to the report for the customer or the salesperson so that the salesperson may freely use the detailed copier usage information. Further, a graph set as shown in FIG. 10 or a data set (not shown in the drawing) may be attached to the report or the detailed copier usage information. The customer or the salesperson may be allowed to freely process and use the graph set or data set.

Thereby, the salesperson, for instance, can process the information and prepare a proposal that matches the needs of her/his customer. The detailed copier usage information and the graph set are not limited to those shown in FIGS. 9 and 10.

The above-describe description is given of the case where the information users are the customer and the salesperson. The customer and the salesperson are preferred information users, but not the sole information users.

For instance, a developer of a customer apparatus may be an information user. In this case, the developer of the customer apparatus can obtain knowledge of the condition and problems of the current apparatus in use from information on the apparatus and make use of the knowledge for the next development. Further, the developer can obtain knowledge as to whether the developed apparatus is being used as it was initially expected to and feed back the knowledge to the next development.

In this case, the terminal of the developer of the apparatus is connected to the network so that the developer may have the information on the apparatus that is processed to be useful for development of apparatuses.

According to this embodiment of the present invention, the customer company can obtain data that supports further progress in cost reduction. Further, the customer company can obtain data for usage of the customer apparatus which data is necessary to obtain the IS014001 certification.

The salesperson can increase the satisfaction of her/his customer in business and gain the confidence thereof.

Further, a proposal that suits the condition of an apparatus user can be made, thus supporting the salesperson in sales promotion.

According to this embodiment, the user (customer) of the apparatus is properly provided with information on the apparatus 1 matching the needs of the user when necessary, and the information on the apparatus 1 is processed and provided to the user of the information such as the salesperson so that the user of the information may be supported.

### Second Embodiment

A description will be given of a second embodiment of the present invention.

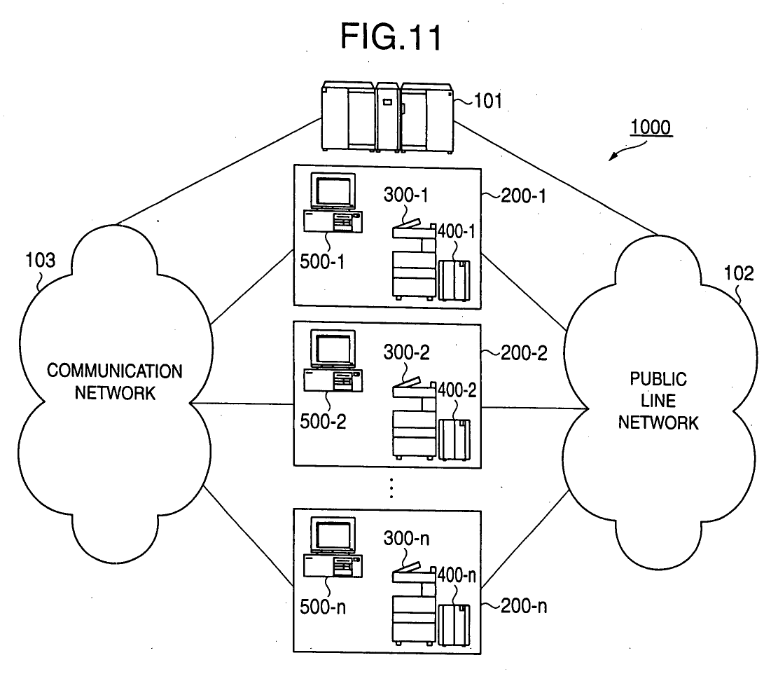

FIG. 11 is a schematic diagram showing a configuration of a system for providing an electronic manual according to the second embodiment of the present invention. In this embodiment, copiers are employed as products and information is collected from companies having the copiers introduced thereinto.

As shown in FIG. 11, an electronic manual provision system 1000 of this embodiment is composed of a public line network 102, a communication network 103, a center 101, a plurality of companies 200-1 through 200-n, a plurality of copiers 300-1 through 300-n, a plurality of transmission apparatuses 400-1 through 400-n that accompanies the copies 300-1 through 300-n, and terminals 500-1 through 500-n.

According to the electronic manual provision system 1000, transmission of information is performed through electrical signals via the public line network 2 and the communication network 3. Each of the terminals 500-1 through 500-n includes a central processing unit (CPU) for operation control, a memory for temporarily storing information transmitted from the center, and a display such as a CRT for displaying the information to each customer.

The public line network 102, which is a general telephone line network, transfers information transmitted from the transmission apparatuses 400-1 through 400-n.

The communication network 103, which is the Internet, for instance, transfers information transmitted from the center 101 to the terminals 500-1 through 500-n. In this embodiment, the Internet is employed as the communication network 103.

The center 101 is a server (including a server computer) managed by an enterprise that manufactures and sells the copiers 300-1 through 300-n. The center 101 collects the information from the transmission apparatuses 400-1 through 400-n via the public line network 102 and provides the information to the terminals 500-1 through 500-n via the communication network 103.

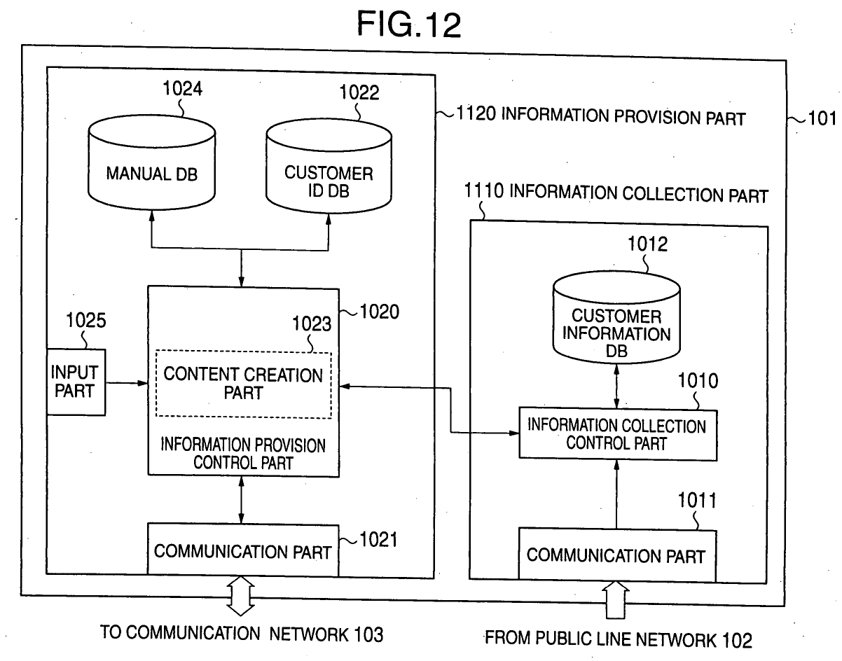

A description will be given, with reference to FIG. 12, of the configuration of the center 101. FIG. 12 is a block diagram showing a configuration of the center 101.

The center 101 is composed mainly of an information collection part 1110 that collects information and an information provision part 1120 that provides an electronic manual.

The information collection part 1110 is composed of an information collection control part 1010, a communication part 1011, and a customer information database (DB) 1012.

The information collection control part 1010 includes a CPU, for instance, and controls every part of the information collection part 1110.

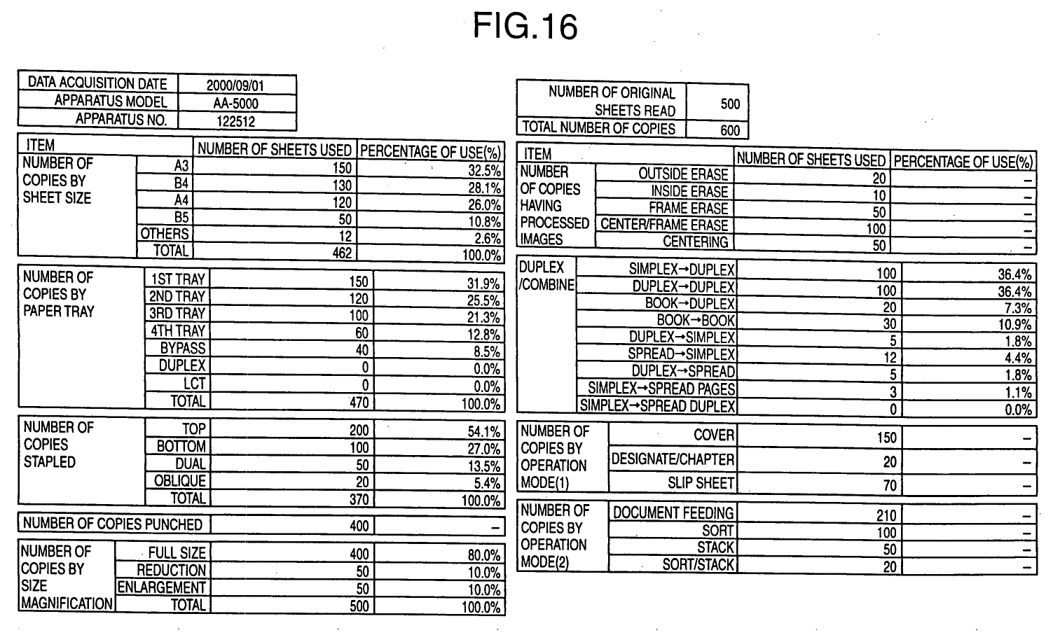

The communication part 1011 is, for instance, a communication device such as a modem, a terminal adapter (TA), or a router, and is connected to the public line network 102 so as to receive from the transmission apparatuses 400-1 through 400-n information on usage (usage information) of the copiers 300-1 through 300-n as shown in FIG. 16.

The customer information database 1012 includes, for instance, a rewritable storage device such as a hard disk unit, and stores the information received by the communication part 1011.

The information provision part 1120 is composed of an information provision control part 1020, a communication part 1021, a customer ID (identification information) database (DB) 1022, a content creation part 1023, and a manual database (DB) 1024, and an input part 1025.

The information provision control part 1020 includes a CPU, for instance, and controls every part of the information provision part 1120.

The communication part 1021 is, for instance, a communication device such as a modem, a TA, or a router, and is connected to the communication network 103 so as to provide information to the terminals 500-1 through 500-n.

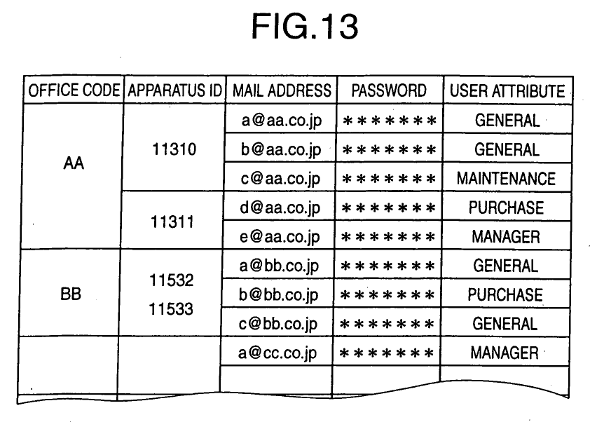

The customer ID database 1022 includes, for instance, a rewritable storage device such as a hard disk drive, and stores identification information for identifying customers as shown in FIG. 13. As shown in FIG. 13, the identification information includes office codes representing offices into which the copiers 300-1 through 300-n are introduced, apparatus IDs that are assigned to the copiers 300-1 through 300-n, mail addresses and passwords of users of the copiers 300-1 through 300-n, and user attributes representing the attributes of the users in using the copiers 300-1 through 300-n.

Here, the user attributes are classified into the following categories: general users who only use the copiers 300-1 through 300-n, maintenance men who are in charge of maintenance such as toner changes of the copiers 300-1 through 300-n, supply purchasers who are in charge of purchase of copier-related supplies such as toners and paper sheets, and managers who are in charge of management of the offices.

The content creation part 1023 creates page data showing information that the information provision part 1120 provides to the terminals 500-1 through 500-n, and includes a CGI program executed in the information provision control part 1020. The content creation part 23 creates, for instance, page data of a file format that is communicable through the communication network 103, such as HTML (Hypertext Markup Language) format.

The manual database 1024 includes, for instance, a rewritable storage device such as a hard disk unit, and stores an electronic manual file showing the contents of each item of the electronic manual transmitted to the customers in a later-described information provision operation. The electronic manual file is composed of HTML data, for instance.

The input part 1025, which is composed of, for instance, a keyboard and a mouse, chiefly makes additions, corrections, and deletions to the stored contents of the customer ID database 1022 and the manual database 1024. For instance, the input part 1025 is used for adding information on a new customer to the customer ID database 1022 and the electronic manual file of a new product to the manual database 1024.

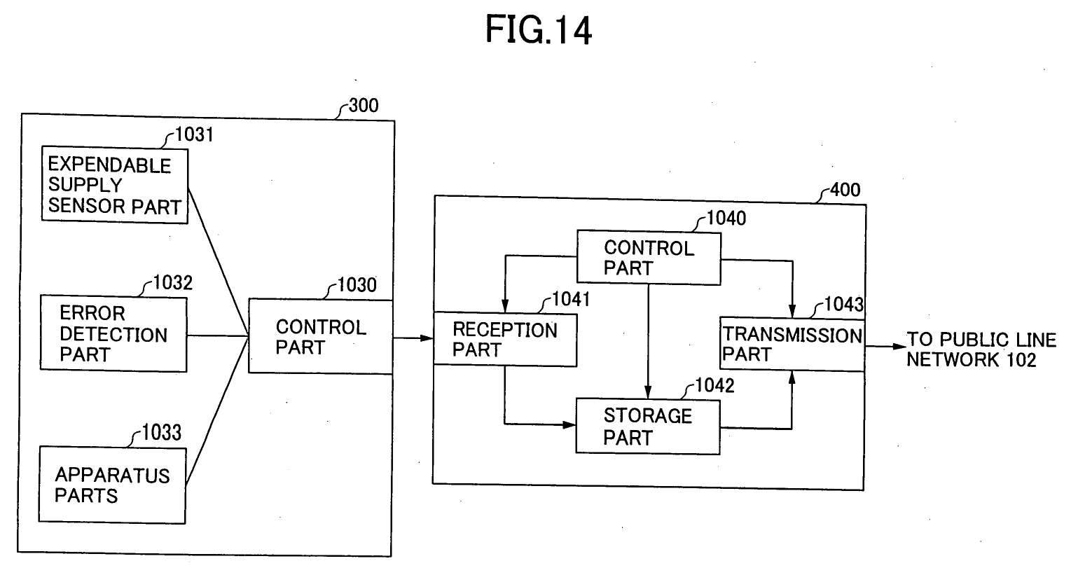

Next, a description will be given, with reference to FIG. 14, of the configurations of each of the copiers 300-1 through 300-n and each of the transmission apparatuses 400-1 through 400-n installed in the companies 200-1 through 200-n. Hereinafter, any of the copiers 300-1 through 300-n and any of the corresponding transmission apparatuses 400-1 through 400-n may be referred to as a copier 300 and a transmission apparatus 400, respectively, for convenience of description. FIG. 14 is a block diagram showing configurations of the copier 300 and the transmission apparatus 400.

The copier 300 is composed of a control part 1030, an expendable supply sensor part 1031, an error detection part 1032, and apparatus parts 1033.

The control part 1030 includes a CPU, for instance, and controls every part of the copier 300. The control part 1030 transfers information (the usage information) from the expendable supply sensor part 1031, the error detection part 1032, and the apparatus parts 1033 to the transmission apparatus 400.

The expendable supply sensor part 1031 detects an amount of use of each expendable supply used in the copier 300, such as the number of copies made, the number of copy sheets used in each paper cassette for holding copy sheets, and an amount of toner used. The expendable supply sensor part 1031 also detects the number of sheets of an original document.

The error detection part 1032 detects a failure occurring in the copier 300, such as a paper jam. If the error detection part 1032 detects a failure, the error detection part 1032 provides the control part 1030 with failure information showing the date of the occurrence of the failure, a part where the failure has occurred, and the state of the failure.

The apparatus parts 1033 are mechanisms composing the copier 300 and operate according to an operation mode specified by the control part 1030.

As shown in FIG. 14, the transmission apparatus 400 is composed of a control part 1040, a reception part 1041, a storage part 1042, and a transmission part 1043.

The control part 1040 includes a CPU, for instance, and controls every part of the transmission apparatus 400.

The reception part 1041 receives the usage information including the amount of use of each expendable supply transmitted from the control part 1030 of the copier 300.

The storage part 1042 includes, for instance, a rewritable storage device such as a hard disk unit, and stores the usage information received by the reception part 1041 for a given period of time.

The transmission part 1043 is connected to the public line network 102 so as to transmit the information stored in the storage part 1042 to the center 101.

In this embodiment, each transmission apparatus 400 is connected to the corresponding one of the copiers 300 (300-1 through 300-n) for simplicity purposes. However, if there are a plurality of copiers in each of the companies 200 (200-1 through 200-n) or on the same floor, the transmission apparatus 400 may be connected to the copiers. Further, although the copier 300 and the transmission apparatus 400 are separated in this embodiment, the copier 300 may be configured to include the function of the transmission apparatus 400.

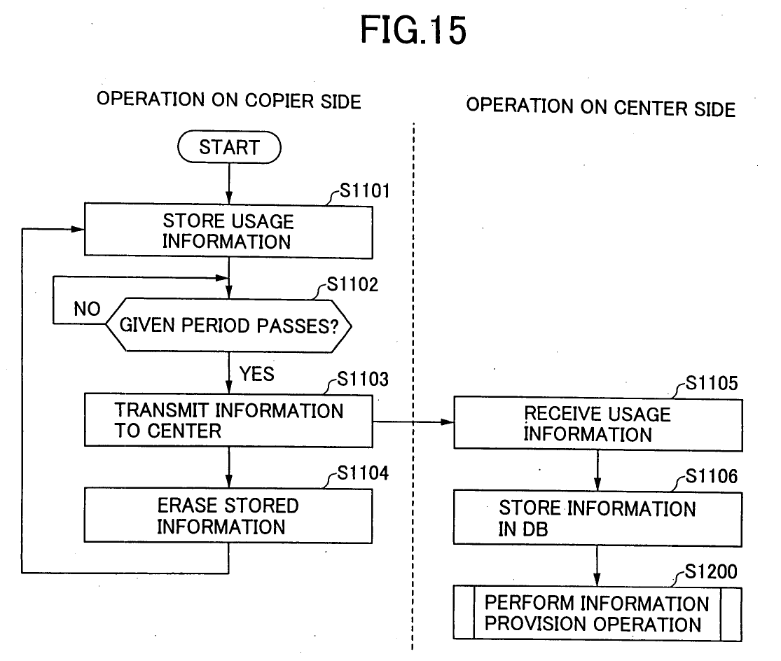

A description will be given, with reference to the flowchart of FIG. 15, of the information collection operation of the electronic manual provision system 1000 of this embodiment. FIG. 15 is a flowchart of an information collection operation performed by the electronic manual provision system 1000.

In step S1101, the copier 300 transmits the information on usage thereof as shown in FIG. 16 to the transmission apparatus 400 in each operation, and the transmission apparatus 400 stores the received information in the storage part 1042. At this point, the copier 300 has the control part 1030 transmit signals detected by the expendable supply sensor part 1031 and the error detection part 1032 and information showing the operations of the apparatus parts 33 to the transmission apparatus 400.

The transmission apparatus 400 transmits the information stored in the storage part 1042 to the center 101 at given intervals. Therefore, in step S1102, it is determined whether a given period of time passes after the last transmission, and if it is determined in the affirmative in step S1102 (that is, “YES” in step S1102), in step S1103, the transmission part 1043 transmits the information stored in the storage part 1042 to the center 101. However, in the case of receiving the above-described failure information, the transmission part 1043 transmits the failure information to the center 101 immediately after its reception.

When the transmission of the information by the transmission part 43 is completed, in step S1104, the control part 1040 erases the information stored in the storage part 1042, and waits to receive next information.

On the other hand, in the center 101, in step S1105, the usage information transmitted from the transmission apparatus 400 in step S1103 is received by the communication part 1011 of the information collection part 1110 and, in step S1106, is stored in the customer information database 1012. At this point, the received information is stored in a part exclusively for the customer of the copier 300 in the customer information database 1012. That is, the received information is stored separately from information from other customers.

In step S1200, the usage information stored in the customer information database 1012 in step S1106 is used in the later-described information provision operation.

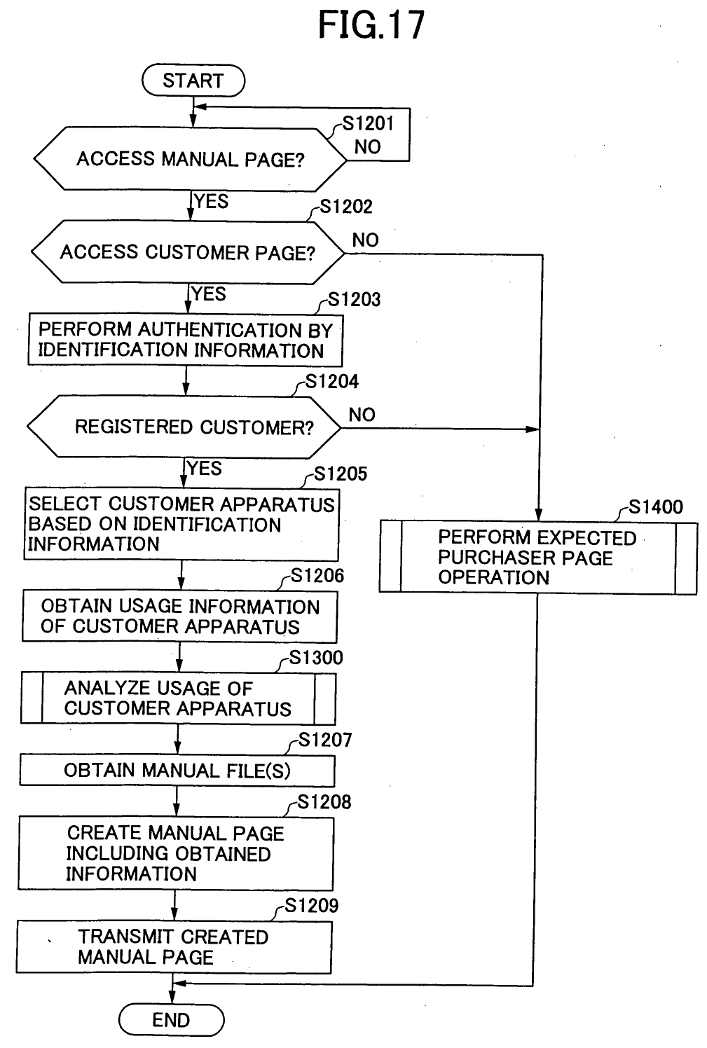

Next, a description will be given, with reference to FIG. 17, of the information provision operation of step S1200 of the electronic manual provision system 1000 of this embodiment. FIG. 17 is a flowchart of an information provision operation performed by the electronic manual provision system 1000.

In this embodiment, the manufacturer and seller company of the copiers 300 has a Web site for presenting the company's information opened on the communication network 103 or the Internet. The Web site is created and provided by the information provision part 1120 of the center 101. Further, this Web site contains a page where the customer can read the electronic manual by accessing the Web site from the terminal 500 (or any of the terminals 500-1 through 500-n) via the communication network 103. Hereinafter, this page is referred to as a manual page.

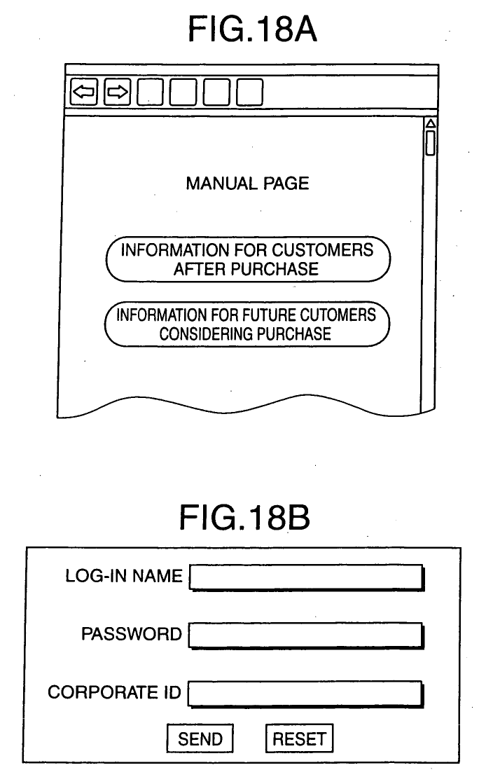

In step S1201, it is determined whether the terminal 500 accesses the manual page. If it is determined in the affirmative in step S1201 (that is, “YES” in step S1201), in step S1202, the information provision control part 1020 transmits a menu page as shown in FIG. 18A to the accessing terminal 500 so that a user of the terminal 500 determines whether to access the manual page prepared exclusively for the customers (registered users).

If the user selects the manual page prepared exclusively for the customers (shown as “information for customers after purchase” in FIG. 18A) in step S1202 (that is, “YES” in step S1202), the information provision control part 1020 transmits a page containing an identification number input screen as shown in FIG. 18B to the terminal 500. When the user inputs given identification information such as log-in name, password, and corporate ID from the terminal 500, in step S1203, a customer authentication operation is performed based on the input information.

Then, in step S1204, the information provision control part 1020 collates the information input from the terminal 500 with the customer ID stored in the customer ID database 1022 so as to determine whether the user is a registered customer.

If it is proved in the customer authentication operation of step S1203 that the identification information input from the terminal 500 does not exist in the customer ID database 1022 or a combination of the identification information is incorrect, the user is not recognized as a registered customer in step S1204. In this case (that is, in the case of “NO” in step S1204), in step S1400, a later-described expected purchaser page operation is performed.

On the other hand, if it is determined in step S1204 that the user is a registered customer, the customer (user) is provided with its individual information.

In step S1205, the information provision control part 1020 specifies the copier 300 of the customer by searching the customer information database 1012 of the information collection part 1110 based on the identification information input from the terminal 500, and in step S1206, obtains the usage information of the copier 300.

In step S1300, the information provision control part 1020 analyzes the usage information of the copier 300 obtained in step S1206 and selects items of the manual to be given priority.

Here, a detailed description will be given of the analysis of the usage information and the selection of the items of the manual (or manual files) performed in step S1300.

First, examples of the manual files selected based on the analysis of the usage information are given as follows:
Manual files relating to functions frequently used.
Manual files relating to functions less frequently used.
Manual files showing methods for failure recovery.
Manual files showing methods of replacing and/or replenishing expendable supplies that are close to a period of replacement or replenishment.
Manual files relating to functions of reducing the number of sheets used if a large amount of sheets are used.
Manual files relating to functional difference from a formerly used copier of a previous model in the case of replacing the former copier with a copier of a new model by purchase.

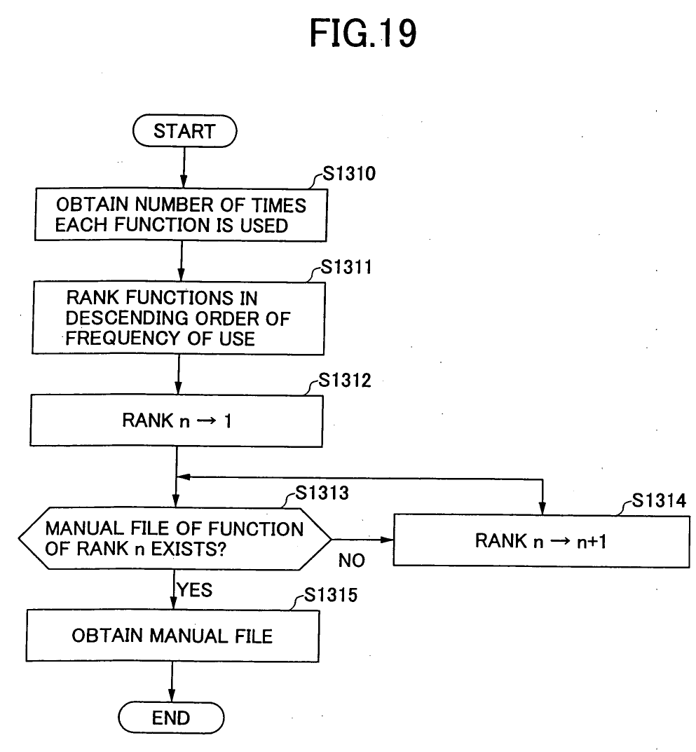

A description will be given, with reference to FIGS. 19 through 24, of the usage analysis operation of step S1300 for selecting the above-described examples.

First, a description will be given, with reference to the flowchart of FIG. 19, of a usage analysis operation for selecting manual files relating to frequently used functions.

In step S1310, the information provision control part 1020 extracts information showing the number of times each function is used in a given period of time from the usage information obtained in step S1206.

Next, in step S1311, the information provision control part 1020 ranks the functions in a descending order according to the number of times each function is used with the most frequently used function being ranked first.

In step S1312 through 1314, the information provision control part 1020 checks whether the functions has their manual files stored in the manual database 1024. The information provision control part 1020 checks each function from the first-ranked one in the order ranked in step S1311. That is, in step S1312, the information provision control part 1020 selects the first-ranked function, and in step S1313, determines whether the first-ranked function has its manual file stored in the manual database 1024. If the information provision control part 1020 determines in the affirmative in step S1313 (that is, “YES” in step S1313), in step S1315, the information provision control part 1020 selects the manual file. If the information provision control part 1020 determines in the negative in step S1313 (that is, “NO” in step S1313), in step S1314, the information provision control part 1020 selects a function ranked second in step S1311, and repeats the operation of step S1313.

Thereby, in step S1315, providable manual files are selected with respect to the frequently used functions.

If there is a copier of a model with higher performance of any frequently used function than the currently used copier 300, the information provision control part 1020 may select the manual file of the copier of the higher performance model with respect to the frequently used function in step S1315. Thereby, the copier of the model with higher performance of the function frequently used by the customer (user) can be introduced thereto. Therefore, a proposal can be made for improvement of efficiency on the side of the user, and at the same time, the sales promotion effect can be expected due to the replacement of the copier 300 by purchase.

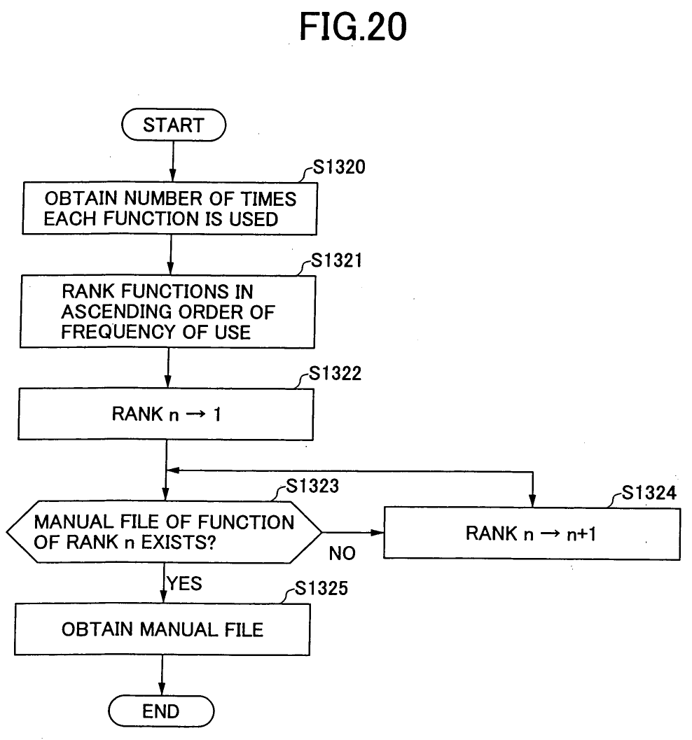

Next, a description will be given, with reference to the flowchart of FIG. 20, of a usage analysis operation for selecting manual files relating to less frequently used functions.

In step S1320, the information provision control part 1020 extracts information showing the number of times each function is used in a given period of time from the usage information obtained in step S1206.

Next, in step S1321, the information provision control part 1020 ranks the functions in an ascending order according to the number of times each function is used with the least frequently used function being ranked first.

In step S1322 through 1324, the information provision control part 1020 checks whether the functions has their manual files stored in the manual database 1024. The information provision control part 1020 checks each function from the first-ranked one in the order ranked in step S1311. That is, in step S1322, the information provision control part 1020 selects the first-ranked function, and in step S1323, determines whether the first-ranked function has its manual file stored in the manual database 1024. If the information provision control part 1020 determines in the affirmative in step S1323 (that is, “YES” in step S1323), in step S1325, the information provision control part 1020 selects the manual file. If the information provision control part 1020 determines in the negative in step S1323 (that is, “NO” in step S1323), in step S1324, the information provision control part 1020 selects a function ranked second in step S1321, and repeats the operation of step S1323.

Thereby, in step S1325, providable manual files are selected with respect to the less frequently used functions.

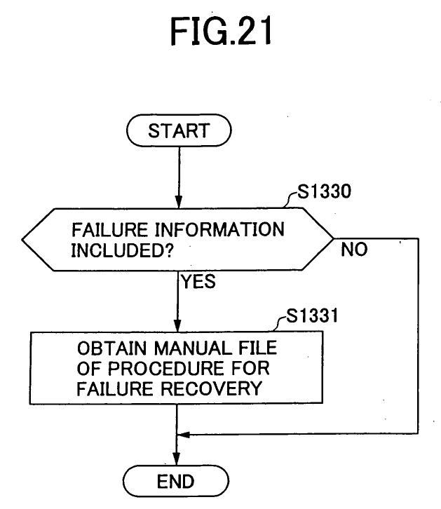

Next, a description will be given, with reference to the flowchart of FIG. 21, of a usage analysis operation for selecting a manual file for failure recovery.

In step S1330, the information provision control part 1020 determines whether the usage information obtained in step S1206 of FIG. 17 includes failure information. If the failure information is not included in the usage information (that is, “NO” in step S1330), the information provision control part 1020 ends the operation.

If the usage information includes failure information (that is, “YES” in step S1330), in step S1331, the information provision control part 1020 specifies the contents of the failure by referring to the failure information, and obtains a manual file showing a procedure for recovery from the failure from the manual database 1024. Thereafter, the information provision control part 1020 ends the operation. However, if the failure is too much for the user to deal with or is dangerous to the user if the user performs a recovery operation, the information provision control part 1020 obtains a manual file showing the contact phone number of a section in charge of repair.

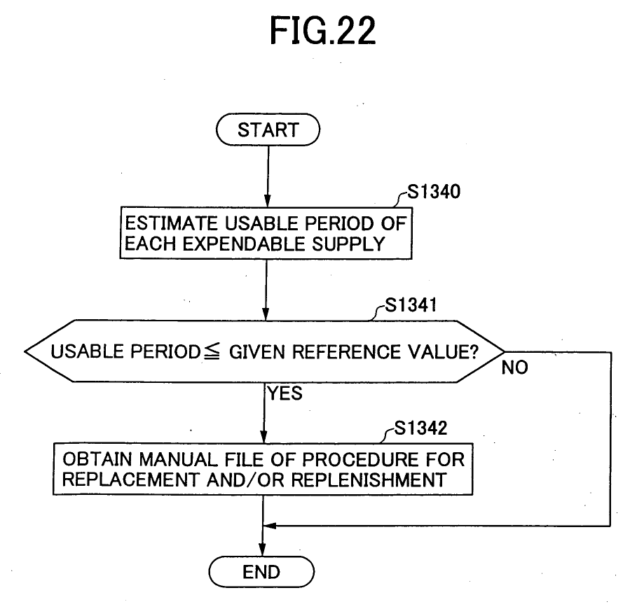

Next, a description will be given, with reference to FIG. 22, of a usage analysis operation for selecting a manual file for the replacement or replenishment of an expendable supply.

In step S1340, the information provision control part 1020 estimates a period of time for which each expendable supply is usable (a usable period of each expendable supply). Here, the information provision control part 1020 analyzes the usage information of the copier 300 for a given period of time (for instance, for the past one month), and calculates a pace at which the copier 300 is used. The information provision control part 1020, by referring to the amount of use of each expendable supply of the copier 300, estimates the number of days for which each expendable supply is usable if the copier 300 is used at the calculated pace.

In step S1341, the information provision control part 1020 determines, with respect to each expendable supply, whether the usable period (days) of the expendable supply estimated in step S1340 is equal to or less than a given reference number of days (for instance, one week or one month).

If the usable period of each expendable supply is more than the given reference number of days (that is, “NO” in step S1341), the information provision control part 1020 ends the operation.

If the usable period of any expendable supply is equal to or less than the given reference period of time (that is, “YES” in step S1341), in step S1342, the information provision control part 1020 obtains a manual file showing a procedure for the replacement or replenishment of the expendable supply from the manual database 1024.

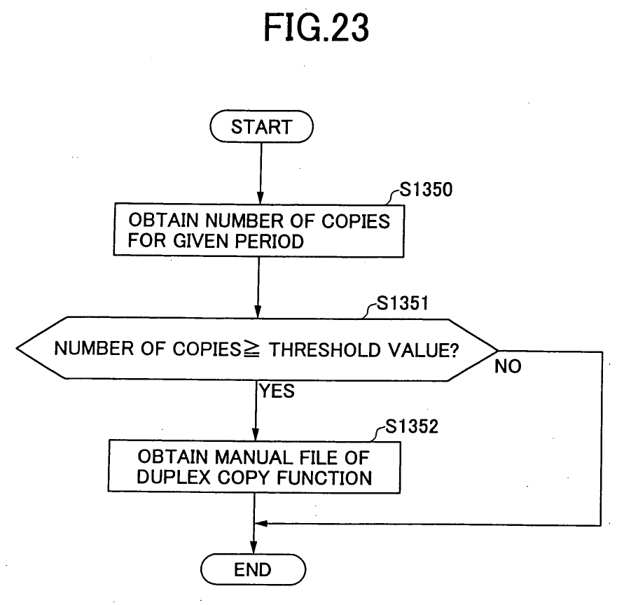

Next, a description will be given, with reference to the flowchart of FIG. 23, of a usage analysis operation for selecting a manual file relating to a function of reducing the number of sheets used if a large number of sheets are used.

In step S1350, the information provision control part 1020 obtains the number of copies made in a given period of time (for instance, one month) from the usage information obtained in step S1206.

In step S1351, the information provision control part 1020 determines whether the number of copies obtained in step S1350 is larger than or equal to a given threshold value (for instance, 1000).

If the number of copies is not larger than or equal to the given threshold value (that is, “NO” in step S1351), the information provision control part 1020 ends the operation.

On the other hand, if the number of copies is larger than or equal to the given threshold value (that is, “YES” in step S1351), in step S1352, the information provision control part 1020 obtains, for instance, a manual file of the duplex copy function from the manual database 24, and ends the operation.

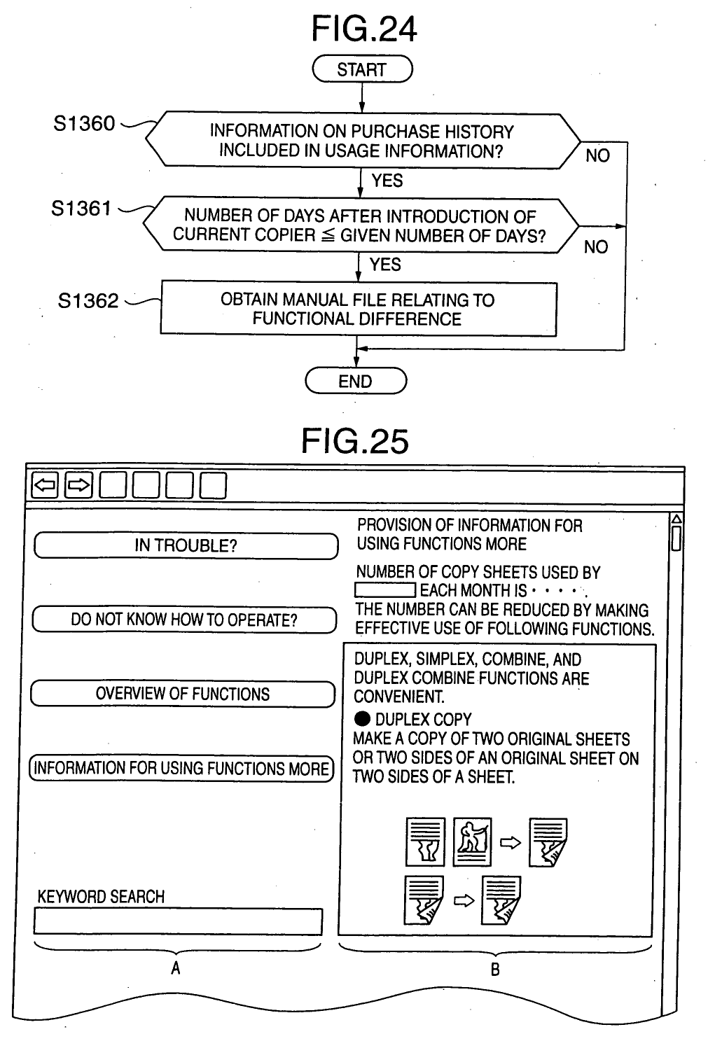

Next, a description will be given, with reference to the flowchart of FIG. 24, of a usage analysis operation for selecting a manual file relating to functional difference from a formerly used copier of a previous model in the case of replacing the former copier with the currently used copier 300 of a new model.

In step S1360, the information provision control part 1020 determines whether the usage information obtained in step S1206 shows the purchase history of the customer. That is, the information provision control part 1020 determines whether the usage information of the copier 300 used by the customer indicates any change in the model of the copier used by the customer.

If there is no change in the copier model (that is, “NO” in step S1360) the information provision control part 1020 ends the operation.

If there is a change in the copier model (that is, “YES” in step S1360), in step S1361, the information provision control part 1020 determines whether the number of days that have passed since the introduction of the currently used copier 300 is equal to or less than a given number of days (for instance, within one month). In this step, the information provision control part 1020 calculates the number of days from the date of the change in the copier model determined in step S1360, that is, the data of the introduction of the copier 300, up to the present.

If the number of days that have passed since the introduction is more than the given number of days (that is, “NO” in step S1361), the information provision control part 1020 ends the operation.

On the other hand, if the number of days that have passed since the introduction is equal to or less than the given number of days (that is, “YES” in step S1361), in step S1362, the information provision control part 1020 obtains a manual file relating to the functional difference between the formerly used copier of the previous model and the currently used copier 300 of the new model from the manual database 24. If the currently used copier 300 and the formerly used copier has functions that are referred to by the same name but are different in the ways the functions are operated or in the contents of their operations, the functions are treated as functionally different.

If there are numerous manual files relating to the functional difference, a manual file that shows a plurality of manual items in a selectable way on a menu may be obtained, for instance. Alternatively, a plurality of given numbers of days may be provided for the determination operation in step S1361 so that, for instance, of the manual files relating to the functional difference, those relating elementary functions may be obtained during the first one month after the introduction of the copier 300 of the new model and those relating to higher functions may be obtained during the next one month.

When, in step S1207, a proper manual file or proper manual files are obtained as a result of the usage analysis operation of step S1300, in step S1208, the information provision control part 1020 controls the content creation part 1023 so that the content creation part 1023 creates a manual page including the obtained manual file(s).

In this step, the content creation part 1023 creates the manual page so that information shown by the manual file(s) obtained in step S1300 is output distinguishably from other information. That is, as shown in FIG. 25, items that are prepared regularly in the manual page, such as a menu item for the user searching for a desired manual item and a region for inputting a keyword, are arranged in a region indicated by A in FIG. 25, and the information shown by the manual file(s) obtained in step S1300 is arranged in a region indicated by B in FIG. 25.

That is, the contents of the manual file(s) selected based on the usage information of the customer are displayed in the first page displayed after the customer who accesses the manual page is authenticated.

In step S1209, the information provision control part 1020 transmits Web page data showing the manual page created in step S1208 to the terminal 500, and ends the operation.

On the other hand, if an access to the manual page for the customers is not selected in step S1202 or if the user is not authenticated as a registered customer, the expected purchaser page operation of step S1400 is performed In this step, an operation for providing the manual page as product information to an unspecified number of people including those planning to purchase products of the manufacturer and seller company of the copiers 300 is performed.

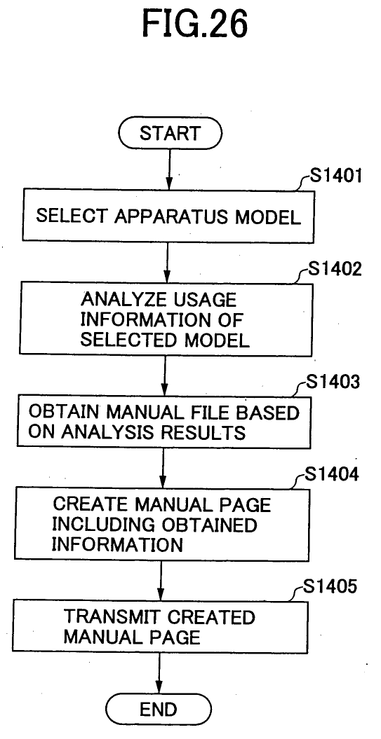

A description will be given, with reference to the flowchart of FIG. 26, of the expected purchaser page operation. FIG. 26 is a flowchart of an expected purchaser page operation.

First, in step S1401, the information provision control part 1020 controls the content creation part 1023 so that the content creation part 1023 creates a page (not shown in the drawing) for inputting a model of an apparatus whose manual a person who wants to read the manual page desires to read, and the information provision part 1023 transmits the created page to the requester terminal 500.

In step S1402, receiving information on the desired apparatus model input by the person who wants to read the manual page from the terminal 500, the information provision control part 1020 obtains and analyzes the usage information of apparatuses of the model. In this step, for instance, frequently used functions of the model may be determined based on the usage information of all customers using the apparatuses of the model in accordance with the same process as is shown in the flowchart of FIG. 19, and the frequently used functions may be determined as the representative functions of the model. If the same failure occurs in many customers, the failure is recognized as characteristic of the model and it is decided that an event that has to be dealt with urgently has occurred.

In step S1403, the information provision control part 1020 obtains a manual file based on the results of the analysis of step S1402.

For instance, if frequently used functions are determined in step S1402, the information provision control part 1020 obtains manual files explaining the functions from the manual database 1024. If the analysis of step S1402 shows that there is a failure that occurs in a large number of apparatuses of the model, the information provision control part 1020 obtains a manual file containing information on recall or repair of the apparatuses of the model.

In step S1404, the information provision control part 1020 controls the content creation part 1023, and the content creation part 1023 creates the manual page so that information shown by the manual file obtained in step S1300 is output distinguishably from other information. In step S1405, the information provision control part 1020 transmits the manual page to the terminal 500, and then ends the operation.

As described above, according to this embodiment, the usage information of the copier 300 of each customer may be collected so that each customer can be provided preferentially with noteworthy manual items (output distinguishably from other information) based on the results of the analysis of its usage information. That is, the noteworthy manual items for each customer are given priority in being provided thereto. Therefore, manual information that each customer may desire at the time of requesting the manual can be provided to each customer immediately.

Further, manual information on the representative functions of the copier 300, for instance, may be provided with priority to a person planning to purchase the copier 300. Therefore, a helpful material for comparison may be provided to the person planning to purchase the copier 300.

In this embodiment, the selections of the frequently used functions and the less frequently functions are taken as examples of the usage analysis operation. However, the usage analysis operation may be performed by combining those selections. For instance, if there are numerous manual items selected as the frequently used functions, less frequently used ones of the selected functions (manual items) are selected. Thereby, functions that are used frequently but not at higher levels of usage can be presented.

Further, in selecting a manual file or manual files in the usage analysis operation in this embodiment, the manual file(s) may be selected based on the user attribute recorded in the customer ID database 1022. For instance, if the customer authenticated in step S1204 is a general user, manual files of elementary contents may be selected, and if the customer is a maintenance man, manual files of advanced contents may be selected.

The present invention is not limited to the specifically disclosed embodiments, but variations and modifications may be made without departing from the scope of the present invention.

The present application is based on Japanese priority applications No. 2000-382590 filed on Dec. 15, 2000 and No. 2001-069164 filed on Mar. 12, 2001, the entire contents of which are hereby incorporated by reference.

1-101. (canceled)

102. A computer-implemented method for tracking usage of an office device by a customer, comprising:
receiving a request for a report on usage of the office device, wherein the request specifies at least one usage type to be included in the report;
acquiring data on usage of the office device by the customer, as specified in the received request, the acquired data being of the at least one usage type;
processing the acquired data to generate processed data; and
preparing the report on usage of the office device by the customer based on the acquired data and the processed data.

103. The method of claim 102, wherein the receiving step comprises:
receiving the request specifying the at least one usage type, the at least one usage type including at least one of (1) usage of at least one paper type, (2) usage of at least one paper size, and (3) usage of duplex printing.

104. The method of claim 102, wherein the receiving step comprises:
receiving the request specifying the at least one usage type, the at least one usage type including usage of at least one feature of the of the device, the at least one feature including at least one of sorting, stapling, and magnification.

105. The method of claim 102, wherein the receiving step comprises:
receiving the request specifying a time period to be covered by the report.

106. The method of claim 102, wherein the receiving step comprises:
receiving the request for the report on the office device, the office device being one of a copier, a printer, and a multifunction office machine.

107. The method of claim 102, wherein the receiving step comprises:
receiving the request, the request specifying an identification of the customer.

108. The method of claim 102, wherein the receiving step comprises:
receiving the request, the request specifying an identification of the office device.

109. The method of claim 102, wherein the receiving step comprises:
receiving the request, the request specifying a format for the report.

110. The method of claim 102, wherein the receiving step comprises:
determining costs associated with usage of the office device for each of the at least one usage type; and
the preparing step comprises preparing the report to include the costs determined in the determining step.

111. A system for tracking usage of an office device by a customer, comprising:
a mechanism configured to receive a request for a report on usage of the office device, wherein the request specifies at least one usage type to be included in the report;
a mechanism configured to acquire data on usage of the office device by the customer, as specified in the received request, the acquired data being of the at least one usage type;
a mechanism configured to process the acquired data to generate processed data; and
a mechanism configured to prepare the report on usage of the office device by the customer based on the acquired data and the processed data.

112. A computer program product storing instructions for execution on a computer system, which when executed by the computer system, causes the computer system to track usage of an office device by a costumer by performing the steps of:
receiving a request for a report on usage of the office device, wherein the request specifies at least one usage type to be included in the report;
acquiring data on usage of the office device by the customer, as specified in the received request, the acquired data being of the at least one usage type;
processing the acquired data to generate processed data; and
preparing the report on usage of the office device by the customer based on the acquired data and the processed data.
